(19) United States
(12) Patent Application Publication
(10) Pub. No.: US 2024/0391019 A1
(43) Pub. Date: Nov. 28, 2024

(54) HIGH SPEED LASER PROCESSES FOR 3D FORMING OF PARTS

(71) Applicant: The Procter & Gamble Company, Cincinnati, OH (US)

(72) Inventors: Joseph Craig LESTER, Liberty Township, OH (US); Philip Andrew SAWIN, Wyoming, OH (US); Benjamin Jacob CLARE, Cincinnati, OH (US); Anthony OGG, West Chester, OH (US); Marc Andrew MAMAK, Mason, OH (US)

(21) Appl. No.: 18/631,142

(22) Filed: Apr. 10, 2024

Related U.S. Application Data
(60) Provisional application No. 63/458,250, filed on Apr. 10, 2023.

(51) Int. Cl. B23K 26/0622; B23K 26/082; B23K 26/342; B33Y 10/00; B33Y 80/00

(52) U.S. Cl. CPC B23K 26/0622; B23K 26/082; B23K 26/342; B33Y 10/00; B33Y 80/00

(57) ABSTRACT

A part 3D printed by a pulse lasing apparatus. The part has a predetermined feature comprising a plurality of 3D prints and voids in a grid pattern. The grid pattern has a plurality of locations disposed along a series of substantially parallel rows, and each location comprises either one 3D print or one void. The pulses from the pulse lasing apparatus form the 3D prints and the absence of a pulse forms the voids. The pulse lasing apparatus is controlled by a computing device that sends packets of instructions to the pulse lasing apparatus, the packet of instructions comprising at least 2, where each individual instruction informs the laser to pulse or not to pulse, creating a 3D print or a void, respectively, at each location on the grid pattern.

### CROSS REFERENCE TO RELATED APPLICATION

This application claims the benefit of U.S. Provisional Application No. 63/458,250, filed Apr. 10, 2023, the substance of which is incorporated herein by reference.

### FIELD OF THE INVENTION

The present invention relates to processes for using high speed pulsed laser to form 3D products.

### BACKGROUND OF THE INVENTION

Short-pulse laser decoration utilizes energy from nano, pico and femto short pulse lasers across a variety of wavelengths and energies to 3D print parts such as products, parts and/or packages. The laser technique used in short pulse laser 3D printing is, importantly, a high through-put technique which uses a stationary laser source from which the laser beam is directed by means of electronically/mechanically controlled mirrors (i.e. “galvo” sets) and lenses (i.e. F-theta and similar lenses) to the product, part or package being 3D printed.

There is a great deal of interest in the possibilities presented by laser-3D printing parts such as by means of short-pulse laser 3D printing. While lasers are improving, and newer lasers have a variety of energies and wavelengths, these 3D printing processes can still be slow and expensive.

The current state of the art for laser 3D printing processes includes “raster” 3D printing processes and “vector” 3D printing processes which are either fast but with poor precision and resolution, or slow but with higher precision and resolution. The combination of high speed and high precision does not exist in the prior art. This problem is particularly notable when 3D printing large parts. A raster laser 3D printing process prints in a grid, and the part is 3D printed by the laser row by row, point by point. Each of the pulses is “gated” such that pulses are only fired for a dark pixel of the image and no pulse is fired for the light pixel of the image (or visa versa). Each of the pulses is individually gated and the pulse energy of each pulse can be varied to produce grayscale. State-of-the-art raster 3D printing processes are effectively limited to lasers with a ˜100 kHz repetition rate given the practical limit of a ˜ 10 μs update rate in signaling the laser's on/off function (i.e. “gating”) and can only be made faster by increasing the pulse-spacing, which can sacrifice fine detail, such as required to 3D print small-font text and graphics.

State of the art vector 3D printing processes can be run above 100 kHz as the pulses are typically gated open while the laser beam is “steered” (by mirrors) in the shape of the vector-lines being 3D printed. Vector-3D printed parts comprising text can often be recognized as the 3D printed lines are typically one-pulse wide (unless in-filled) and the pulses become closer together near the corners, where the surface velocity of the laser beam was slowed as it turned the corner. However, it has been found that the accuracy of the placement of the 3D prints with vector-3D printing suffers at very high surface velocities of the laser beam.

There are various manufacturing methods for generating 3D structures where a lasering apparatus plays a central role in the 3D buildup process. General terms for these are laser 3D printing (or 3D laser printing) and stereolithography. Terms like selective laser melting (SLM) or selective laser sintering (SLS) refer to the processes with which solid material is formed. Another technique is known as Laser Metal Deposition (LMD). In this case, a powder is fed co-axially through a nozzle into the focused laser spot and fully dense functional metallic components can be produced. Another laser technique known as stereolithography (SLA) uses shorter wavelength lasers to locally photopolymerize a liquid.

The two main attractions of 3D laser printing are: a large number of different parts can be fabricated without making any specialized tools; and, a wide range of different parts can be made. One only needs to change the lasing instructions but does not need to make any specialized tools and methods. In other words, only software needs to be tailored, not hardware and general fabrication strategies.

Another advantage of 3D printing is that objects with complex geometries can be flexibly fabricated without first fabricating specialized fabrication tools, such as dies. A 3D printer is a very versatile fabrication machine, directly turning software structures into real objects. Such printing processes have been developed for a range of materials, including metals, ceramics and polymers. Constant wave (CW) and pulsed lasers with wavelengths that are activated, absorbed, or otherwise compatible with the material being printed are used for these applications. For example, 1064 nm wavelength can be used for metal melting/sintering, while UV 355 nm can be used for photopolymerization.

Structures can be made which would be close to impossible to fabricate with other methods. The freedom in design is much greater, much less limited than usually by capabilities of fabrication methods. For example, one can make parts containing open channels with rather complicated shapes, which could not be fabricated e.g. with drilling. Sometimes, a large number of such openings may serve for efficiently cooling a machine part with some fluid flow through cooling channels.

There are three main categories of SLA processes, laser-based stereolithography (laser SLA), digital light processing stereolithography (DLP-SLA), and masked SLA (MSLA). For all these processes, a vat of photo-reactive liquid resin is selectively exposed to light in order to form very thin solid layers that stack up to create one solid object.

Laser-based SLA was the original means of stereolithography that was developed in 1986 by Charles Hull, co-founder of 3D Systems. The technology works by using a UV laser to draw each layer of the object and uses two mirrors driven by a motor, known as galvanometers or ‘galvos’ (one on the X axis and one on the Y axis), to rapidly aim the laser beam across the print area, solidifying resin as it moves along. In order to create a solid object the design must be broken down, layer by layer, into a series of points and lines that are given to the ‘galvos’ as a set of coordinates and the laser traces them out.

DLP-SLA uses a digital projector to flash a single image of each layer across the entire platform at once. Because the image of each layer is digitally displayed, it is composed of numerous square pixels, resulting in a layer formed from small rectangular bricks called voxels that stack up along the Z axis. DLP-SLA Orthodontic 3D printer examples: Park Dental Research/Orchestrate Juell Flash OC, Envisiontec Vida, etc.

An example for an extreme application of 3D printing is the fabrication of essential parts of rocket engines. The opportunity to create computer-designed complex structures, which are optimized for gas flow and stability despite minimum weight, is important, while limitations like material cost and processing time are less relevant.

Rapid manufacturing can also be conveniently used for replacement parts. It is generally not very economic to produce and store sufficient numbers of replacement parts for various kinds of machines, particularly in cases where the model cycles are relatively short, and new kinds of parts are required all the time. With 3D laser printing one may store only the recipe in computerized form and produce such replacement parts on demand.

Thus, there remains the need for faster, more economical, and more precise laser-3D printing. Both the hardware and the software that controls the lasing devices can be improved as well as the methods of using these improved lasing devices. Further, the disposition of the laser 3D prints on the part can be improved to provide for both precision and speed.

Thus, it would be desirable to provide improved lasing devices together with software for operating the lasing devices and a process to 3D print parts with high-speed and high-precision (such as directly reproducing label information, aesthetic and functional features). These improvements should make the process fast, simple, cost-effective and scalable to mass manufacture and allow for the resulting parts to have consumer and machine-readable features that, among other benefits, can replace labels and adhesives.

### SUMMARY OF THE INVENTION

The present invention provides a solution for one or more of the deficiencies of the prior art as well as other benefits. The specification, claims and drawings describe various features and embodiments of the invention, including a 3D part printed by a pulse lasing apparatus. The part has a series of over-lying layers, and each layer has a plurality of 3D prints. The pulses from the pulse lasing apparatus form the 3D prints and the absence of a pulse forms the voids.

In an embodiment of the present invention, the pulse lasing apparatus is controlled by a computing device that sends packets of instructions to the pulse lasing apparatus, the packet of instructions comprising at least 2 individual instructions. Each individual instruction informs the laser to pulse or not to pulse wherein the over-lying layers comprise 3D prints and voids in a grid pattern. The grid pattern is a plurality of locations disposed along a series of substantially parallel rows, and each location has either one 3D print. Further, the pulses from the pulse lasing apparatus form the 3D prints and the absence of a pulse forms the voids. Each individual instruction informs the laser to pulse or not to pulse, creating a 3D print or a void, respectively, at each location on the grid pattern. The grid patterns have locations disposed along the rows with each pair of adjacent locations being separated by an X-distance, and there are two or more substantially parallel rows and each adjacent pair of substantially parallel rows is separated by a Y-distance.

In another embodiment the Y-distance is greater than the X-distance and the locations between adjacent parallel rows are stacked, alternatively, the locations between adjacent parallel rows can be offset. Likewise, the locations in the two-dimensional layers can be stacked or offset in the Z-direction. The individual instructions within a packet can be any combination of 3D prints and voids including all 3D prints or all voids.

In yet another embodiment of this inventions, there is a method of 3D printing a part by a pulse lasing apparatus, the method including the steps of defining a series of over-lying layers comprising a plurality of 3D prints and voids in a grid pattern, the grid pattern comprising a plurality of locations disposed along a series of substantially parallel rows, wherein each location comprises either one 3D print or one void.

This method further has the step of forming the 3D prints by pulsing the pulse lasing apparatus and creating voids by not pulsing the pulse lasing apparatus, and controlling the pulse lasing apparatus with a computing device that sends packets of instructions to the pulse lasing apparatus. The packet of instructions comprising at least 2 individual instructions, wherein the individual instruction inform the pulse lasing apparatus to pulse or not to pulse, creating a 3D print or a void, respectively, at each location on the grid pattern. At least one of the rows are 3D printed by 2 different packets. Alternatively, at least one of the rows are 3D printed by 3 different packets. The packet of instructions further contains two or less, preferably, only one individual instruction relating to the position of a location in the grid pattern.

The present invention provides many benefits over the prior art, including that 3D printing of objects, or parts, can be done with much higher precision, and much greater speed than pulse lasing 3D printing of the past.

### BRIEF DESCRIPTION OF THE DRAWINGS

FIG. 1 is a schematic view of a lasing apparatus according to the present disclosure.

FIG. 2 is a grid according to the present disclosure wherein the locations in adjacent parallel rows are stacked.

FIG. 3 is a grid according to the present disclosure wherein the locations in adjacent parallel rows are offset.

FIG. 4A is an alphanumeric character in a grid pattern 3D printed in accordance with the present invention.

FIG. 4B is an alphanumeric character in a grid pattern 3D printed in accordance with a prior art process.

FIG. 5 shows a standardized rectangle pattern laser printed by a vector laser process of the prior art compared to the same pattern laser printed according to the present invention.

FIG. 6 is an exemplary grid of the standardized rectangle according to the present invention.

FIG. 7 illustrates the % Mismark calculation.

FIG. 8 is an illustration of 3D printings made as a result of packets of information sent to a laser controller according to the present invention.

FIG. 9 is an illustration of 3D printings made as a result of packets of information sent to a laser controller according to the present invention.

FIG. 10 is an illustration of 3D printings made as a result of packets of information sent to a laser controller according to the present invention.

FIG. 11 is an illustration of 3D printings made as a result of packets of information sent to a laser controller according to the present invention.

FIG. 12 illustrates the “stage” method of 3D printing with a laser.

FIG. 13 illustrates an inverted method of 3D printing with a laser.

### DETAILED DESCRIPTION OF THE INVENTION

3D Printing Operation 3D laser printing methods generally works with a bath of liquid or powder, having a smooth surface. A laser beam is then moved over the top surface, irradiating some parts of it, causing the solidification, while not hitting other parts. Often, the laser beam is moved just along lines in arbitrary directions, which is referred to as the vector method. In other cases, the whole area is systematically scanned, and the laser beam is turned on only for those parts to be processed, which is referred to as the raster method. One may also combine those methods, for example vector scanning for the contours followed by raster scanning for the inner parts.

The flat structure is lowered slightly into the bath, so that its surface is covered with a thin layer of liquid or powder. Swiping over the surface with a solid object may help to get a smooth surface of the bath. One can then use the laser to create a layer of solid material on the flat structure. This process is repeated until the full height of the wanted solid workpiece is created.

FIG. 13 illustrates the “stage” method of 3D laser printing. Lasing apparatus 301 and stage 303 are both controlled by computing system 305. Computing system 305 raises and lowers stage 303 in the Z-direction 307. Stage 303 initially starts near the top of liquid 306, which is contained in vat 302. Lasing apparatus 301 begins by selectively laser curing a portion of liquid 306 on stage 303 to form the first layer of part 304. When the first layer is complete, stage 303 is lowered slightly into vat 302 to allow a fresh layer of liquid to cover part 304. Lasing apparatus 301 then repeats the selective laser curing of liquid 306 to for the second layer of part 304. Those skilled in the art will appreciate that the thickness of each individual layer will be determined by the type and power of the laser used, as well as the intricacy of the part being printed. Also, each successive layer may be the same or different as the layer below it, again, depending on the design of the part desired. While “liquid” is used in the description of FIG. 13, it is understood by those skilled in the art that the liquid could also be finely granulated metal particles as well.

Afterwards, the created piece is taken out of the bath, remaining liquid or powder is removed, and possibly some additional processes such as polishing are applied to improve the surface quality. The remaining unprocessed powder or liquid can be used for the next part to be fabricated.

Another possibility is that the irradiation occurs from the bottom, e.g. through a glass sheet below the bath. The made workpiece is then step-by-step pulled upwards to allow fresh powder or liquid to get to its bottom.

FIG. 14 illustrates the 3D printing of inverted head (part 321) using a glass plate 326. Base 322 starts near glass plate 326 so that there is a thin layer of liquid 323 there between. Liquid 323 is contained in vat 325. Lasing apparatus 320 selectively cures a portion of liquid 323 onto base 322 to form the first layer of part 321. Base 322 is then moved in the Z-direction 324 to allow a new layer of liquid 323 to flow between glass plate 326 and part 321. Lasing apparatus 320 then cures a new layer of liquid 323 to form the next layer on part 321. Both lasing apparatus 320 and base 322 are controlled by computing devises, not shown. As was the case with the stage 3D printing of FIG. 13, those skilled in the art will appreciate that the thickness of each individual layer will be determined by the type and power of the laser used, as well as the intricacy of the part being printed. Also, each successive layer may be the same or different as the layer below it, again, depending on the design of the part desired. While “liquid” is used in the description of FIG. 14, it is understood by those skilled in the art that the liquid could also be finely granulated metal particles as well.

There are other methods where the curing of the liquid is accomplished below the top of the liquid. Such methods can involve sub-surface curing of the liquid by a confocal lasing apparatus. In such a method, the focal point of the laser is below the top of the liquid so that the fluence of the laser spot required to cure the liquid is achieved below the top surface of the liquid.

There are other methods where the source material is continuously supplied during the process with some kind of feed mechanism. Such processes are generally automated to a large extent, carried out by some kind of 3D laser printer device. Still, one often requires some amount of manual work, e.g. for filling the bath, removing and cleaning the workpiece, etc.

Suitable lasers for SLA include pulsed fiber lasers and other solid-state lasers. When 3D printing metals, one usually requires an inert gas like nitrogen or argon for protecting the metal against oxidation.

For melting polymer materials, one often uses a CO2 laser at 10.6 μm wavelength; such light is usually well absorbed by polymers. It is common to heat the whole bath with a separate infrared source, so that relatively little laser power is required, and the resulting temperature gradients are weak. That helps to obtain better quality results.

Another possibility is to use laser-induced polymerization. Here, the original material is a liquid containing some monomers, and short-wavelength light (e.g. 355 nm pulsed lasers) is used to trigger some activator for starting the polymerization.

3D fabrication processes for ceramics are not yet as developed as those for metals and polymers, but different processes are possible. One may e.g. use a suspension or paste as raw material, which can exhibit a sufficiently homogeneous distribution of ceramic particles (e.g. alumina or zirconia). Such a suspension can contain a photo-curable organic binder material; binding of the ceramic particles by radical polymerization of the binder material can be initiated e.g. with blue laser light.

### Part

“Part”, as used herein refers to an individual object that is manufactured. The part may be a container, non-limiting examples of which include bottles, bags, wraps, drums, jars, cups, caps, and the like. The part can be made of any a variety of common materials including; polymers (i.e. PET, PETG, HDPE, PP, PVOH, LDPE, LLDPE, engineered resins), metals (i.e. aluminum, steel or other alloys), ceramics, glass.

It is understood that the parts produced by the 3D printing processes of the present invention are intended to be three dimensional, they are produced by a series of 2 dimensional layers. Thus, the present specification talks about grids and printing in two dimensions, it is understood this applies to the printing the 2D layers of a 3D part. For example, the 3D part may consist of a series of over-lying layers resulting from laser-printing in two dimensions; that is the 2D layers that are laser-printed in two dimensional grids are over-laid to form the 3D part.

A part according to the present invention may be formed of a single thermoplastic material or resin or from two or more materials that are different from each other in one or more aspects. For example, the part may comprise one or more of a thermoplastic resin, selected from the group consisting of polyethylene terephthalate (PET), polyethylene terephthalate glycol (PETG), polystyrene (PS), polycarbonate (PC), polyvinylchloride (PVC), polyethylene naphthalate (PEN), polycyclohexylenedimethylene terephthalate (PCT), glycol-modified PCT copolymer (PCTG), copolyester of cyclohexanedimethanol and terephthalic acid (PCTA), polybutylene terephthalate (PBCT), acrylonitrile styrene (AS), styrene butadiene copolymer (SBC), or a polyolefin, for example one of low-density polyethylene (LDPE), linear low-density polyethylene (LLPDE), high-density polyethylene (HDPE), propylene (PP) and a combination thereof. Similarly the part may comprise an engineered resin or a ceramic or a metal.

There are a variety of polymer resins available for use in SLA (stereolithography) 3D laser printing. The materials used in SLA are photosensitive thermoset polymers that come in liquid form including but not limited to PLA, ABS, Nylon, Resin, PETG, TPU, ASA, PEI (engineered plastic).

Metallic structures can be fabricated with various kinds of steel, or with alloys of nickel, titanium or aluminum. One can use a powder with grains of only one type of metal, or a mixture of different materials, where only one of those is melted and helps to hold the other metal particles together. The technique is also called selective laser melting.

Instead of laser melting, one may employ laser sintering. Here, the laser does not completely melt the material, but only bakes together the grains of powder. In the case of metallic powders, the method is also called direct metal laser sintering. With that approach, a wide range of materials can be used. However, the sintered material usually still exhibits some significant porosity, i.e., a lower density and a weaker mechanical strength.

A modified method is indirect sintering or two-step sintering, where the laser treatment creates only a preliminary porous structure, which afterwards is sintered again with a heat treatment. In that process, one may introduce another metal with lower melting point (e.g. copper), which fills the microscopic voids in the porous structure of the other metal (e.g. steel). That way, one avoids substantial shrinking of the structure.

The thermoplastic materials may include monomers derived from renewable resources and/or monomers derived from non-renewable (e.g., petroleum) resources or a combination thereof. For example, the thermoplastic resin may comprise polymers made from bio-derived monomers in whole, or comprise polymers partly made from bio-derived monomers and partly made from petroleum-derived monomers.

In some cases, the part produced with 3D printing is not made for direct use, but only serves for the production of a casting form, with which more parts, replicates, can be made of another material by some kind of casting. The replicas can then consist a very stable material, which would not be easy to use directly in 3D printing. However, such methods strongly restrict the possible range of geometries, because inner structures could not be replicated that way.

Tooling is also a preferred use of 3D laser printing. Tooling means the fabrication of fabrication tools, such as casting forms or workpiece fixing tools. While standard tools are available for many processes, some processes need very specialized tools, but often not in large numbers, e.g. since one tool can be used for making many items of the final product.

### Laser and Lasing Apparatus

A pulse laser such as a short pulse laser may be used to 3D print the parts according to the present invention. Lasers for use in the present invention are commercially available and include nano, pico, and femto second lasers. These short pulse lasers can emit pulses applied at high energy-densities and high repetition rates, the high energies and high repetition rates are important to allow laser-3D printing the part at high speed. The laser 3D prints themselves include 3D prints made by melting, photopolymerization or photo-curing material to form an object such as a product, part or package.

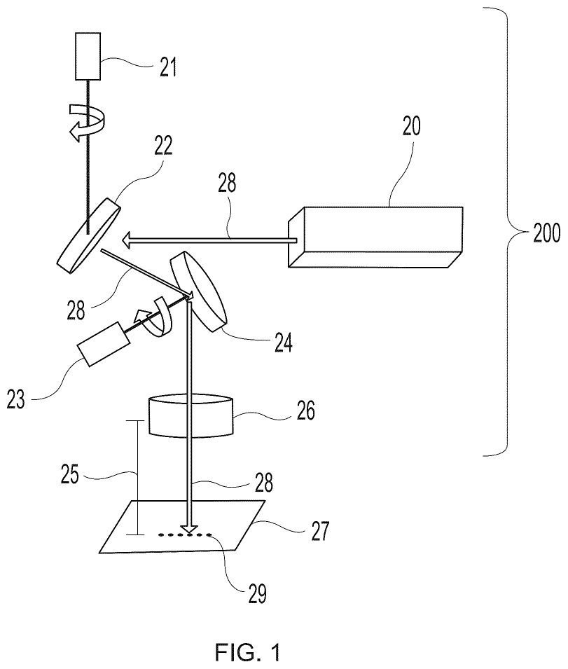

Any suitable laser can be used to 3D print the part 10. FIG. 1 shows one example of a lasing apparatus 200 comprising a laser 20 useful for 3D printing a part in accordance with the present invention. The lasing apparatus 200 includes a laser 20 which may be any laser capable of generating sufficient energy to 3D print the parts, such as a UV laser, having power in the range of 1 W to 60 W, and a laser wavelength of 355 nanometers or an IR 3D printing laser, having a power in the range of 1 W to 300 W, or even 500 W, and a laser wavelength of 1064 nanometers. Such lasers are available from various suppliers, including an IPG ULPN-355-10-1-3-M 3D printer or YLPN-1-1x350-50-3M MOPA module, available from IPG Photonics of Oxford, MA, United States. Other makes and types of lasers are also possible and different power ranges and settings may be used. The lasing apparatus can include optics that can be used to direct the laser beam, and/or to modify the laser beam such as by changing the energy density and/or spot size of the laser beam 28, as desired.

Frequency or Repetition Rate, measured in Hz, is the number of laser pulses a single laser can deliver in a second. For instance, a 1 MHz laser delivers 1,000,000 pulses per second where a 100 kHz repetition rate laser delivers 100,000 pulses per second. Repetition rate can be important for processing a particular lasing job in a short amount of time (i.e. high-speed laser 3D printing). The more pulses per unit time available correlates (inversely) to the time required to 3D print a given row for a particular job almost linearly.

Pulse Energy is the amount of energy a single laser pulse contains and is typically measured in μJ or mJ. Typically, pulse energy is in the range of 0.001 mJ to 3000 mJ, more preferably 0.1 mJ to 2000 mJ, more preferably 0.1 mJ to 1000 mJ, more preferably 5 μJ to 1000 μJ (2 mJ), more preferably in the range of 7 μJ-1000 μJ, and more preferably 10 μJ-300 μJ. The average power of the laser, then, is given as the pulse energy times the repetition rate.

Average power=pulse energy (J)*rep rate (Hz or 1/sec).

Peak power is equal to pulse energy divided by pulse duration, and pulse duration can be less than 100 nanoseconds, less than 50 nanoseconds, less than 20 nanoseconds, less than 10 nanoseconds, or less than 1 nanosecond. Therefore, pulse energy and pulse duration are linearly related to peak power. Shorter pulse durations achievable with nanosecond, picosecond and femtosecond lasers allow for very high peak power which aids in the ability to 3D print parts.

In the lasing apparatus 200 depicted in FIG. 1, the laser 20 projects laser beam 28 onto X-mirror 22 which is rotated by X-galvo 21. X-mirror 22 and X-galvo 21 collectively form an X-galvo set. Laser beam 28 is then projected onto Y-mirror 24 which is rotated by Y-galvo 23. Y-mirror 24 and Y-galvo 23 collectively form a Y-galvo set. The X and Y mirrors 22 and 24 respectively, work together to direct laser beam 28 to the location where the desired 3D print 29 is to be 3D printed on part 27. Before laser beam 28 reaches part 27, it will typically go through a lens 26. The distance from lens 26 to part 27 is the focal length 25.

The combined optics of the lasing apparatus may function so as to sweep the laser beam across the surface of the part in successive passes. The laser beam may sweep across the part along a first row in the grid in an X-direction, being directed by the X-mirror, while emitting (or omitting) pulses. The combination of the sweep-speed of the laser beam across the surface of the part, also called the surface velocity of the laser beam, and the repetition rate of the laser pulses, then, determines the spacing of 3D prints along the X-direction.

X-spacing*Repetition Rate=Surface Velocity

The laser may emit a pulse or pulses while sweeping across the part at a given location thereby resulting in a 3D printed location (or locations), or the laser may omit pulse(s) while sweeping across the part at a given location thereby resulting in unmarked location(s) (i.e. void(s)). The laser beam may be swept across the part at a constant surface velocity while emitting and/or omitting pulses. The surface velocity or sweep-speed is defined above. The laser beam may subsequently sweep across the part along a second row of the grid (such as a row adjacent to the first row) while emitting (or omitting) pulses. The laser beam may sweep across the first and second rows in the same direction or in opposite directions. For example, the laser beam may sweep across the first row from “left-to-right” and across the subsequent/adjacent row from “right-to-left”.

### Laser 3D Printing

The parts of the present invention are typically 3D printed by the process of foaming, carbonization, ablation, etching, reduction, oxidation, and/or phase change. The term foaming means a process whereby the laser beam melts and vaporizes a portion of material which creates gas bubbles that become trapped within the molten resin and reflect the light diffusely when cooled.

When carbonizing a material, the laser heats up the surface of the material (generally to a minimum 100° C.) emitting oxygen, hydrogen, or a combination of decomposition products. Carbonizing generally leads to dark 3D prints with higher carbon content versus the original material, making it a good choice for lighter colored parts, while the contrast is rather minimally shown on darker materials.

There are additional methods of 3D printing a part. For example, annealing is a unique laser process available for metals and other materials. The energy from the laser beam creates an oxidation process below the surface of the material, which results in a change of color on the material surface.

Spot-size is an important parameter of the laser 3D printing of the present invention and relates to the focused area where the laser beam contacts the part. “Spot size” is the diameter of a round spot. The spots are round, but it is possible to achieve elliptical spots by control of the laser beam optics relative to the part. The spot size can be modified by focusing or de-focusing the laser beam, but the “fluence” (=energy per unit area) within the spot decreases as the spot is enlarged or de-focused. Theoretically, the minimum spot-size achievable with any laser is the wavelength of the laser itself. As a practical matter, the minimum spot size achievable with pulse lasers is ˜7-20 μm. The spot sizes of the laser 3D printings of the present invention can be in the range of from about 10 μm to about 150 μm, preferably from about 20 μm to about 100 μm, more preferably from about 30 μm to about 80 μm, and even more preferably from about 40 μm to about 60 μm. As discussed in the Background of the Invention, the spot sizes for conventional laser-3D printings for date codes (for example using CO2 lasers) and the like are a minimum of 250 μm and can exceed 800 μm. Another way to think about spot size in a 3D printing context is the size of the paintbrush an artist is using to paint. If you want very fine detail, then smaller spots sizes would be utilized. Larger areas to be covered may prefer larger spots sizes. However, laser 3D printing mechanisms require a minimum fluence to achieve the desired 3D print so balancing pulse energy, pulse duration, pulse overlap and spot size are critical.

Further, there is a region around the laser-contact spot which may also be heated in the course of the 3D printing, though little or no material would be 3D printed. This “heat-effected zone” can still yield effects such as crystallization which can impact the appearance and/or performance of the target material. Short pulse lasers (e.g. nano-second lasers) have some heat effected zone, although substantially less than micro-second pulsed or CW type lasers, (e.g. CO2, longer pulse IR lasers, etc.). Pico and Femto second lasers are often termed “ultra-short pulse” and have very little to no heat effected zone. This capability is helpful to control the thermal effects of the 3D printing.

Geometry of the 3D print spacing is a key contributor to the cycle time and fluence (or energy per unit area) provided to a part. For example, the spacing between 3D prints may be such that the 3D prints do not overlap at all and have 0% overlap. At 0% overlap, each individual laser pulse is responsible for the energy provided to 3D print the part. If the laser does not have sufficient pulse energy or peak power to achieve a desired 3D print, then one can decrease the pulse spacing to the point where the spots overlap in either one or both the X and Y-directions; overlapping the spots includes providing more than one laser pulse to the area of the part in which the spots overlap which provides higher fluence or energy per unit area to that portion of the part. Additionally, pulse spacing is a key lever for cycle time. If a laser has a fixed repetition rate or pulse frequency, then to achieve the lowest process-time (also called cycle-time) one would want to spread the pulses out as much as possible while still achieving the desired 3D print type and 3D print contrast. In one embodiment of the present invention, the pulses are non-overlapping.

Pulse Duration is the length of time a pulse remains continuously above half its maximum value. The shorter the pulse, the higher the peak power can be created with a common average power. This is because average power=pulse energy (J)*rep rate (Hz or 1/sec). Peak power is equal to pulse energy divided by pulse duration. Therefore, when pulse duration gets significantly smaller, the resulting peak pulse power is significantly higher. This peak power enables improved melting, photopolymerization or photocuring at a surface being 3D printed. Short pulse lasers take advantage of this phenomenon to 3D print parts and enable 3D printing mechanisms typically not found in longer pulse lasers.

### Packeting

One way the current CV-bitmap process can overcome the 10 μs limit update rate is to include multiple individual instructions in one packet of instructions to the pulse lasing apparatus. That is, individual instructions to pulse or not to pulse, in a single update that results in the laser emitting a pulse creating a 3D print, or omitting a pulse leaving a void. In such a process, each row may contain 3D printed and unmarked locations according to the packet of instructions.

The constant-velocity of the laser sweep-speed provides that the X-spacing within these chains of multiple 3D prints (or voids) will remain consistent. Recalling that the laser sweep speed is determined as:

X-distance*repetition rate=surface velocity

increasing the repetition rate of the laser from 100 kHz to 200 kHz doubles the sweep-speed of the laser beam and can help reduce cycle-time.

Of course, including multiple individual instructions in a single update improves the intricacy of the pattern that can be produced. While a laser-3D printing process that includes only one pulse per update (i.e. employing the 10 μs update rate and a 100 kHz repetition rate laser) can produce intricacy to a single 3D print or void, such as:
3D print-void-3D print-void-3D print-void
   the same process employing a 200 kHz laser would have twice the sweep-speed but could only produce such detail as:
3D print-3D print-void-void-3D print-3D print-void-void-3D print-3D print-void-void

The sweep speeds of the laser beam across the surface of the part in the current CV-bitmap process are much faster than those achievable with currently available laser-3D printing processes such as raster and vector 3D printing processes.

The packets of individual instructions defined herein may be communicated to the lasing apparatus at regular time intervals, such as every 10 μs. The packets of individual instructions defined herein contain 3D print/void information as described above but may also contain additional instructions in each packet. For example, a packet of information might include individual instructions related to position of the locations to be 3D printed. Those skilled in the art will appreciate that to increase the speed and accuracy of the overall pulsed laser 3D printing process, it desirable to do two things. First, each packet of information should include the maximum number of individual instructions that the processor will allow, and second, the number of instructions related to 3D prints/voids, should be maximized with respect to other instructional information in the same packet.

To illustrate the packeting concepts of this invention one might think of a vehicle such as a bus. There might be, for example, 2, 4, 8, 16, 32, 64 or more, seats on a given bus. It is axiomatic that driving a bus from point A to point B that has 16 seats with only 4 people on board is an inefficient use of the bus. Likewise, filling each packet of information with the maximum number of individual instructions will increase efficiency of the overall process. Further, if you have a bus with only 8 seats, and you fill 3 of those seats with location or positional instructions, you have only five seats left for 3D print/void instructions, which is the desired result of the process.

The pulsed laser 3D printing processes of this invention operate with a constant laser repetition rate and a constant surface velocity when moving the laser beam across a given row of locations, with a brief deacceleration/re-acceleration process at the turn-around point at the end of each row. During this turn-around process the laser is not 3D printing. Further, the rows are linear, so the only directional change occurs, again, at the end of each row. During the brief turn-around period, the packets of instructions may include a greater amount of positional information.

Similarly, the constant surface velocity and constant repetition rate provide that the locations along a given row are largely predetermined (i.e. the consistent X-distance) at the outset of the 3D printing informed by any given packet. As such, with the exception of the beginning and end of each row, the packets of individual instructions may require only one positional instruction. The positional instruction may include X-, and Y-, and Z-components. It is understood that when laser-3D printing on a planar surface, the Z-component of the position information may be consistently zero.

Because the pulsed laser moves at constant surface velocity, the end point of the 3D printing informed by one packet determines the beginning point for the next packet. Thus, the one individual instruction related to position serves the dual purpose of the end location for one packet and the beginning locations for the next. Those skilled in the art will appreciate that speed is defined as distance traveled divided by the time required to travel that distance. Each packet has a set time, and the one positional instruction tells the lasing apparatus how far to travel, which defines the speed. Thus, no additional instructions related to speed are required freeing up more computational space (e.g. seats on the bus) for 3D print/void instructional information. This simplification of speed and position maximizes the number of individual instructions related to 3D print and void. This speeds up the entire process and makes it much more accurate. This level of efficiency for packet-use cannot be achieved with the prior art process (i.e. raster, vector) that, for example, draw borders, and then fill in between the lines. Those prior art processes require additional amounts of speed and position information within each packet of information.

Thus, a part can be 3D printed by a pulse lasing apparatus to create a predetermined feature comprising a plurality of 3D prints and voids in a grid pattern. The grid pattern is made up of a plurality of locations disposed along a series of substantially parallel rows, wherein each location comprises either one 3D print or one void. The pulses from the pulse lasing apparatus form the 3D prints and the absence of a pulse forms the voids. The pulse lasing apparatus is controlled by a computing device that sends packets of instructions to the pulse lasing apparatus, the packet of instructions comprising at least 2, preferably at least 4, more preferably at least 8, and even more preferably at least 16, or even at least 32 or at least 64 or more individual instructions, wherein each individual instruction informs the laser to emit a pulse towards the surface or not, creating a 3D print or a void, respectively, at each location on the grid pattern. The packets of instructions may be provided to the lasing apparatus at a 10 μs update rate. The update rate at which the packets may be provided to the lasing apparatus may be less than 10 μs, preferably 7.5 μs, or 5 μs or even 2.5 μs (μs=micro seconds).

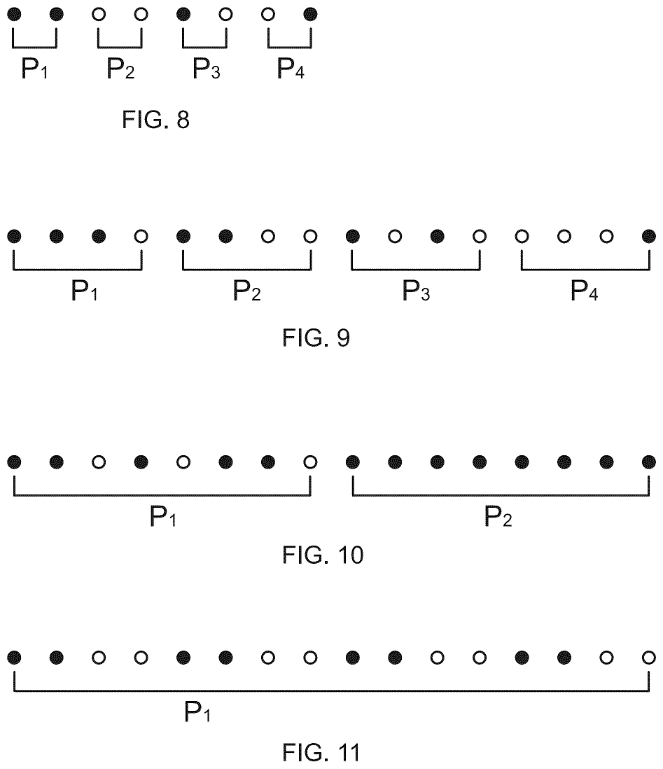

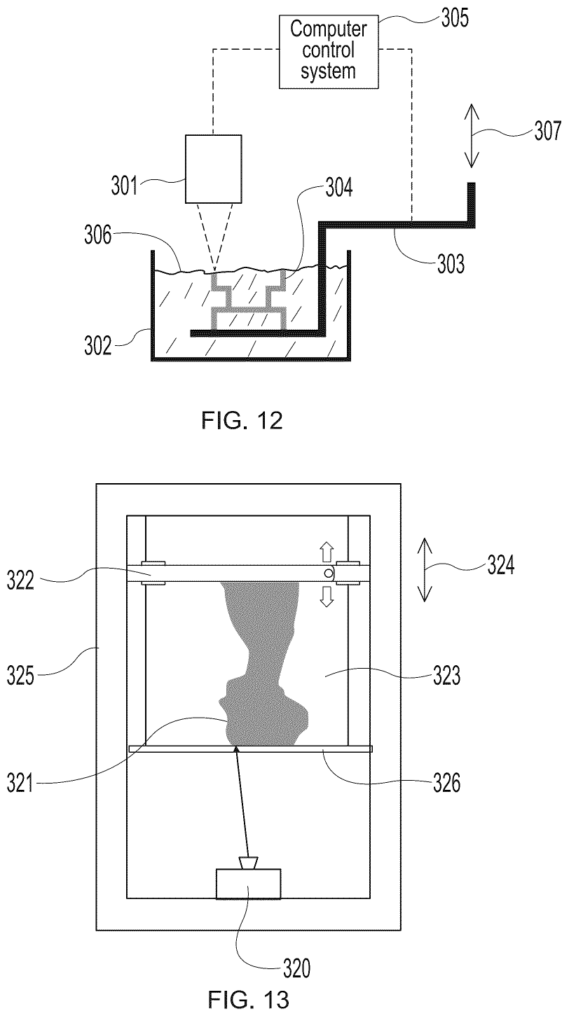

FIG. 8 is an example of one row of a grid pattern with packets P1, P2, P3 and P4 each containing 2 individual instructions to the pulse lasing apparatus. P1 instructs the pulse lasing apparatus to pulse twice, making two 3D prints. P2 instructs the pulse lasing apparatus to not pulse twice, leaving two voids. P3 instructs the pulse lasing apparatus to pulse once, then not pule once creating one 3D print and leaving one void. P4 instructs the pulse lasing apparatus to do the opposite of P3. Those skilled in the art can use this system of 3D prints and voids in a grid pattern to form any of a variety of predetermined features as defined herein.

FIG. 9 is an example of one row of a grid pattern with packets P1, P2, P3 and P4 each containing 4 individual instructions to the pulse lasing apparatus. P1 instructs the pulse lasing apparatus to pulse three times and not pulse once, creating three 3D prints and one void. P2 instructs the pulse lasing apparatus to pulse twice, then not pulse twice creating two 3D prints and leaving two voids. P3 instructs the pulse lasing apparatus to pulse once, not pulse, pulse again, then not pulse creating a 3D print-void-3D print-void pattern. P4 instructs the pulse lasing apparatus to not pulse three times then pulse once creating three voids and one 3D print.

FIG. 10 is an example of one row of a grid pattern with packets P1 and P2 each containing 8 individual instructions to the pulse lasing apparatus. P1 instructs the pulse lasing apparatus to pulse twice, not pulse, pulse, not pulse, pulse twice, and not pulse. P2 instructs the pulse lasing apparatus to pulse eight times. It is understood that polygon scanners of the prior art can send two or more instructions to a pulse lasing apparatus. But the instruction are all pulse, or all not pulse. For example, a polygon scanner can send eight on pulses then eight no pulse instructions. These polygon scanners of the prior art cannot send individual instructions according to the present invention. Those skilled in the art will appreciate the incredibly improved versatility achieved by controlling each and every location with a 3D print or a void as taught by the present invention. Predetermined features, can be 3D printed on surfaces with incredible speed and accuracy by utilizing the individual packeted instructions of the present invention.

FIG. 11 is an example of one row of a grid pattern with packet P1 containing 16 individual instructions to the pulse lasing apparatus. P1 instructs the pulse lasing apparatus to pulse two times then not pulse twice. This pattern is repeated three more times for a total of 16 individual instructions in one packet of information.

There is further provided herein a method of 3D printing a part by a pulse lasing apparatus comprising the following steps. First, define a predetermined feature comprising a plurality of 3D prints and voids in a grid pattern, the grid pattern comprising a plurality of locations disposed along a series of substantially parallel rows. Each location comprises either one 3D print or one void. Then form the 3D prints by pulsing the pulse lasing apparatus and create the voids by not pulsing the pulse lasing apparatus. Of course, you are not “creating” a void, you are simply leaving behind a non-3D printed location that is defined as a “void” by the present specification. The pulse lasing apparatus is controlled by a computing device that sends packets of instructions to the pulse lasing apparatus, the packet of instructions comprising 2, preferably 4, more preferably 8, and even more preferably 16 or more individual instructions. Each individual instruction informs the pulse lasing apparatus to pulse or not to pulse, creating a 3D print or a void, respectively, at each location on the grid pattern.

### Grid

As used herein a “grid” or a “bitmap grid” is taken to mean a regular periodic array of locations that may include the plurality of laser-induced prints. The array of prints may be formed in the grid as a two-dimensional layer in the X- and Y-directions, and a series of two-dimensional layers may be over-laid in the Z-direction to form the 3D part. The periodicity of the array includes periodicity in both the X and Y-directions. The plurality of 3D prints within the grid may or may not be present at each of the locations within the grid. That is to say, a 3D print may be formed at a location within the grid or may be absent at the location (i.e. a void). As mentioned, the lasing apparatus sweeps the laser beam across the part while the laser pulses are either emitted from the laser or no pulse is emitted. A 3D printed location occurs when the laser emits a pulse to a given location and an unmarked location results when the laser does not emit a pulse to a given location. The laser beam may be swept across the part at a constant surface velocity while the repetition rate of the laser is constant, so the periodicity of locations will be regular (i.e. the X-distance) in the direction in which the laser beam is swept across the part (i.e. the X-direction) even though the spacing of 3D printed locations may not be equal, given the possibility of unmarked locations. In the event of unmarked locations, the distance between any 3D printed locations along the same direction (ie. in the X-direction) may be an integer (ie. 2×, 3× or larger) of the smallest distance measured between 3D prints in that direction.

The laser beam may be swept across the part in subsequent rows. The laser beam may be swept from left-to-right or from right-to-left and may sweep in the same direction as it is moved from row to row (e.g. like the carriage-return on a typewriter, as in a raster process) or may be swept in alternating directions as it moves from row to row. A key contributor to reducing cycle-time includes sweeping the laser beam in alternating directions as it moves from row to row. The rows may be generally parallel to one another. The distance between adjacent rows is the Y-distance. The locations in adjacent rows may lie directly above/below one another or may be offset relative to one another. It is appreciated that an offset that is equal to the X-distance results in a realignment of the locations between rows.

As previously discussed, the laser 3D prints may be non-overlapping to reduce the time required to 3D print a given pattern (i.e. “time-to-3D print”). Time to 3D print can be further reduced by spacing-out the 3D prints in either or both of the X- and/or Y-directions, however, this increased spacing can lead to poor coherence of the prints and a fragile and/or highly porous 3D part. For example, increasing the X-distance allows for a faster surface velocity of the laser beam across the surface of the part when 3D printing a given row (at a constant repetition-rate). Increasing the Y-distance allows for fewer turnarounds in the course of 3D printing a given predetermined pattern. Alternately, the 3D prints may be touching or even overlapping to increase the strength and/or reduce the porosity of the resulting 3D part.

The X-distance is preferably in the range of from about 0.005 mm to about 0.500 mm; more preferably from about 0.010 mm to about 0.100 mm; and even more preferably from about 0.040 to about 0.075 mm. The Y-distance is preferably in the range of from about 0.010 mm to about 2.0 mm; more preferably from about 0.050 mm to about 0.150 mm; and even more preferably from about 0.060 mm to about 0.075 mm.

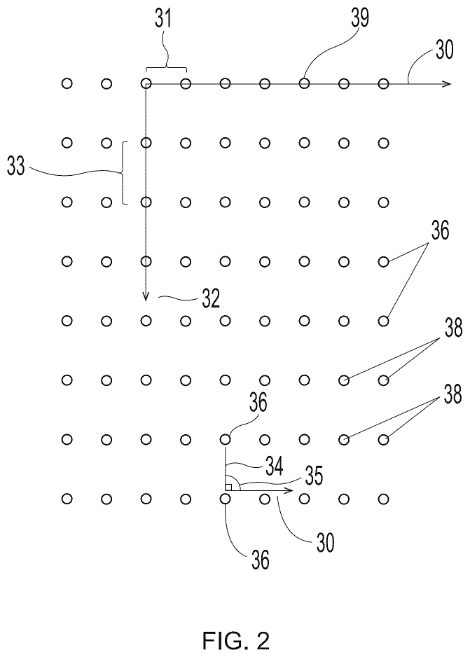

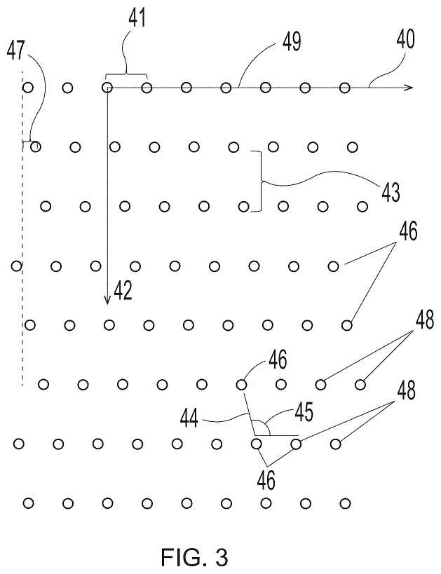

FIGS. 2 and 3 all show various depictions of grids according to the present invention. More specifically, FIG. 2 is a grid 39 according to the present invention illustrating the X-direction 30, Y-direction 32, X-distance 31 and Y-distance 33. Potential 3D printing locations 36 are depicted by the empty circles making up the grid. Further, in FIG. 2 the locations 36 among parallel rows 38 are “stacked” when the angle 35 between locations in adjacent row 34 drawn in the Y-direction between two potential 3D printing locations and the X-direction 30 is approximately 90 degrees. In other words, if one uses vectors to connect neighboring 3D prints from the array to form a parallelogram (i.e. unit cell), when the interior angles of the parallelogram are approximately 90 degrees, the locations are stacked. When the interior angles of the parallelograms differ from 90 degree (i.e. 120 & 60 degrees), the locations are offset. X-distance is measured from the center of one location to the center of an adjacent location in the X-direction.

Those skilled in the art will appreciate that the unit cell of a grid has four symmetrical axes horizontal, vertical, and two diagonals. The laser 3D printing discussed herein can occur along any of those four axes.

FIG. 3 is another grid 49 according to the present invention showing an offset 44, having an offset distance 47 between adjacent parallel rows 48. Offset 44 is defined by angle 45 between locations 46 in one row 48 and the nearest location 46 in an adjacent row 48, wherein an offset 44 exists when angle 45 is greater than or less than 90 degrees. FIG. 3 further shows X-direction 40, X-distance 41, Y-direction 42, and Y-distance 43.

The periodicity of the locations comprising the grid includes periodicity in the X-direction and periodicity in the Y-direction. The X-direction and Y-direction may be generally orthogonal to one another. As depicted in FIGS. 2 and 3, the grids 39 and 49, respectively, may take the form of equally spaced locations along successive parallel rows. The direction parallel to the successive parallel rows is taken as the X-direction (30, 40) and the direction generally perpendicular to the X-direction is taken as the Y-direction (32, 42). The spacing between adjacent locations along any of the parallel rows (e.g. in the X-direction) is taken as the X-distance (31, 41), and the distance between adjacent parallel rows is taken as the Y-distance (33, 43).

The grid 39 may be a stacked grid as depicted in FIG. 2. In a stacked grid, the locations where the 3D prints may be applied along a first row are directly above the locations along a second row immediately below the first row. Said another way, the angle 35 formed between the row-segment connecting a first location along the first row with an adjacent location along the first row and the row-segment connecting the first location with its nearest location along the second row is 90°. In a stacked grid, the spacing between adjacent locations along the X-axis is equal to the X-distance 31 and the shortest spacing between adjacent locations between adjacent X-axes is the Y-distance 33.

The grid may be an offset grid as depicted in FIG. 3. In an offset grid 49, the locations where the 3D prints may be applied along a first X-axis are not directly above the locations along a second X-axis immediately below the first X-axis. Said another way, the angle 45 formed between the row-segment connecting a first location along the first X-axis with an adjacent location along the first X-axis and the row-segment connecting the first location with its nearest location along the second X-axis is greater than or less than 90°.

Just as the locations (i.e. comprising either prints and voids) within the two-dimensional grids comprising the two-dimensional layers can be stacked or offset, subsequent over-laid grids can also include stacked or offset locations in the Z-direction. Locations in adjacent overlying layers are “stacked” when the angle between adjacent locations in adjacent over-lying layers is approximately 90 degrees to both the X- and Y-directions as defined by the grid in either of the adjacent layers. Locations in adjacent overlying layers are offset when the angle is different from 90 degrees.

An offset configuration of layers may be desirable, for example, when the print-spacing within a layer includes non-overlapping or non-touching prints within the individual layer grids. For example, where the prints within a given two-dimensional layer are non-overlapping and non-touching, these prints can be bridged by use of an offset configuration of layers, where a print in an adjacent layer overlaps or touches multiple non-overlapping and non-touching prints.

The over-lying layers in the Z-direction may be unequally or equally spaced along the Z-direction. This spacing is the Z-spacing. The 3D part may include periodicity in the Z-direction wherein the Z-spacing between adjacent layers is similar among the over-lying layers comprising the 3D part. The Z-spacing can be as small as a few nanometers or as large as a few millimeters and may depend on the size of the 3D prints and/or the stacked/offset nature of the configuration of the two-dimensional layers. The Z-spacing is preferably in the range of from about 2 nm to about 2 mm; more preferably from about 1 μm to about 1 mm; more preferably from about 10 μm to about 500 μm; and more preferably about 20 μm to about 200 μm.

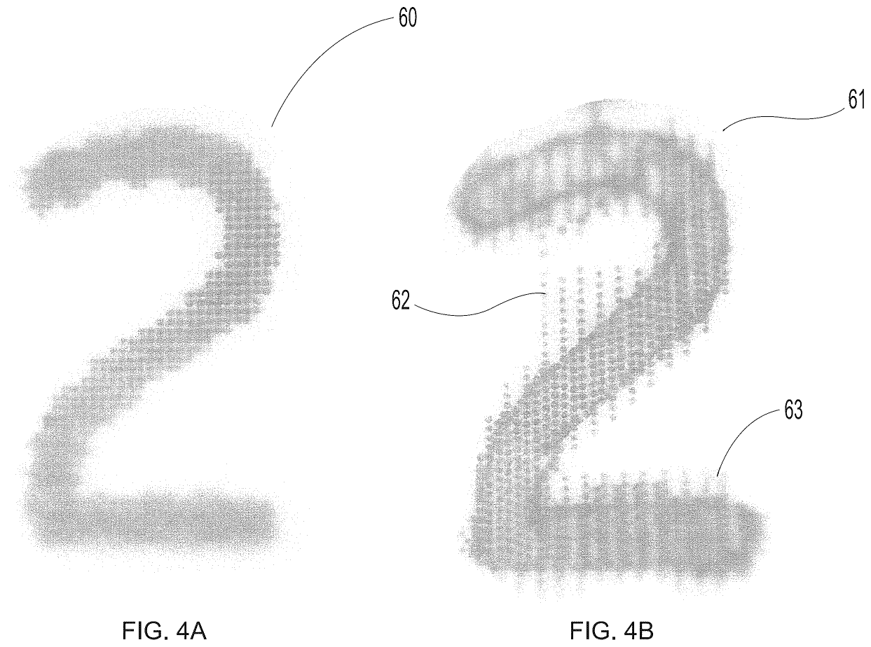

Those skilled in the art will appreciate that the X-direction and Y-direction defining any two-dimensional layer are somewhat arbitrarily chosen relative to the predetermined pattern. For example, FIG. 4B depicts an example of a “2” made by laser 3D printing wherein the X-direction is vertical with respect to the 3D printed “2” 61. Those skilled in the art will appreciate that the X-direction could just as easily been horizontal with respect to the 3D printed “2” 61.

Those skilled in the art will appreciate that any conventional laser-printing process may be used in conjunction with the CV-bitmap laser-printing process. For example, a 3D part comprising over-lying CV-bitmap printed layers may further comprise additional prints formed by a vector process. On example includes a 3D part in which the interior prints comprising the part are formed from the inventive CV-bitmap process, and an outline or exterior portion of the 3D part may be formed by a vector process.

Those skilled in the art will appreciate that the grid (e.g. 39 and 49) and the regular spacing between adjacent locations assumes a planar surface of the part. Where the part surface is curved, the spacings may vary with the curvature of the surface.

FIGS. 4A and 4B illustrate the difference between laser 3D printing via bitmap grid 3D printing with the inventive CV-bitmap process 4A, and the prior vector 3D printing process 4B. in both cases an alphanumeric character 60 and 61 (i.e the number “2”) is 3D printed with a laser. The alphanumeric character 60 is substantially better defined with clean, crisp edges, and very few stray 3D printings. FIG. 4B stands in stark contrast, with largely undefined edges and a substantial number of stray 3D printings 62 outside the border of the alphanumeric character 61. Both characters 60 and 61 were 3D printed in approximately the same amount of time.

### Laser 3D Printing Rate Improvement

As discussed, the present invention can laser 3D print parts faster and with more precision than prior processes. Existing raster processes are very slow, but relatively accurate, while the vector laser 3D printing processes are faster and accurate at low speeds but very sloppy at high speeds resulting in unclear 3D printings that are hard to read by consumers or machines. Raster and vector are different graphic file types that require different modes of laser processing. The main differences between modes required to laser process each type involve the movement of the galvos, or laser beam steering, and in the parameters used.

The vector path typically is slower for images because of the multiple fixed short start and stop points that require the galvo set to spend time accelerating to a user set maximum surface velocity (determined by the pulse spacing multiplied by the repetition rate) and the length of the vector distance. Lengthy vector distances allow the vector lasing apparatus to reach its maximum surface velocity, while shorter vector distances have the lasing apparatus constantly accelerating and decelerating and never reaching the maximum surface velocity, resulting in longer 3D printing cycle times.

The vector process is also less accurate than the CV-bitmap process at high speeds, due to the acceleration/de-acceleration of the galvos steering the laser beam. Specifically, the location of each laser 3D print must be communicated from a computer driven software to the laser 3D printing apparatus and such communication must be updated during the 3D printing of the predetermined pattern, for example, as the laser beam traverses a given row. Typical update frequencies for this communication are ˜10 μs, so a laser outputting pulses with a repetition rate of 100 kHz would allow for an update in the communication for each individual location in the grid. This is also true of raster laser 3D printing processes which may further include variation of the pulse power for each pulse as a means of achieving grayscale (e.g. dithering). As the surface velocity of the laser beam across the surface of the part increases, repetition rates of greater than 100 kHz are required to achieve the desired X-spacings within the rows, and each update from the software must now communicate the location of multiple laser 3D prints (or voids/non-3D prints). While the calculations can be performed nearly instantaneously, it is believed that in the extremely fast time-domains of high-speed laser 3D printing, the galvos can not respond as quickly, and the accelerate/de-accelerate profile of the vector process results in a significant number of misplaced 3D prints within a given row, versus the constant surface velocity profile of the present invention.

FIG. 4B depicts the effect of running a vector-type process at high speed when 3D printing text involving alphanumeric characters and the misplacement of 3D prints within a row. The figure shows many rows displaced from one another where the 3D printing either initiated too early or too late, so that the outline of the alphanumeric character is jagged and the overall appearance is blurred and potentially illegible (e.g. one cannot distinguish an “8” from an “0”).

In contrast, the process and resulting patterns of the present invention can be created by a constant surface velocity (CV) bitmap path. The CV-bitmap laser 3D printing process allows for increased speed and increased precision because there are no start and stop points within a row, but rather a user defined maximum surface velocity (again, the pulse spacing multiplied by the repetition rate) that is constant while applying pulses or 3D printing. Moreover, the lasing apparatuses of the present invention can increase speed when not 3D printing over relatively long distance (relative to the X-distance). For example, if there is a distance of 2-3 mm (or more) between 3D printings in one row of 3D prints, the lasing apparatus can accelerate without losing accuracy; otherwise the laser beam is moved at a constant surface velocity while pulsing. This is yet another reason the 3D printing systems of this invention are faster and more accurate than prior devices.

Smaller galvos sets (e.g. including lower mass mirrors) enable higher acceleration to reach this user defined maximum surface velocity. One can tune these galvos to high acceleration values that allow the mirror to reach its desired angular velocity in a lower amount of time. Interestingly, these values can be tuned specifically for bitmap processing at higher values vs. vector processing. Additionally, in vector laser software there is a maximum 3D printing surface velocity limitation set such that the laser 3D prints are close to their desired commanded position. As one increases the maximum surface velocity threshold, the laser pulses have more error vs. their desired position in vector processing. It is noted that in CV-bitmap 3D printing mode, since the surface velocity (e.g. both the angular velocity of the mirrors and the surface velocity of the laser beam) is constant during the 3D printing process, one can increase the maximum surface velocity threshold significantly achieving an overall lower 3D printing cycle time vs. vector, and still maintain pulses in their predetermined position.

The angular velocity of the galvo sets is important to job cycle time as it relates directly to the laser beam's surface velocity across the part. The surface velocity of the laser beam is set by the angular velocity of the galvo/mirror pairs and the focal length of the lasing apparatus.

surface velocity=galvo angular velocity(rad/sec)*focal length (mm)

The surface velocity when producing laser 3D prints within a given row is primarily controlled by the X-galvo/mirror set. Job cycle time can be more dependent on the laser surface velocity in the X-direction than in the Y-direction, and the X-galvo/mirror set may be more responsive than the Y-galvo/mirror set. For example, the mirror on the X-galvo/mirror set may be smaller (i.e. lower mass, smaller mirror size, lower inertia, higher acceleration motor capability)

The surface velocity of the laser beam across the surface of the part in the current CV-bitmap process are much faster than those achievable with currently available laser 3D printing processes such as raster and vector 3D printing processes. Current processes typically exemplify surface velocity on the order of 1-2 m/s or less. The CV-bitmap process of the present invention provides for surface velocities above 8 m/s, and further surface velocities equal to or greater than 10 m/s, 15 m/s, 18 m/s, 22.5 m/s, 32.5 m/s, 45 m/s, 60 m/s and even as high as 90 m/s or higher.

The sweep path of the laser beam across the surface of the part can also contribute to reduced cycle time. Conventional raster laser 3D printing processes sweep the laser beam across the rows in either the right-to-left or left-to-right directions, also known as unidirectional, and “jumps” the laser beam back after 3D printing each row to start the subsequent row (like a carriage return on a typewriter). In this way, subsequent rows can be easily registered (i.e. stacked) and grid-locations can be lined-up based on this consistent starting point. To eliminate the jump distance and reduce the time between each 3D printed row, the current CV-bitmap process uses a “bi-directional” process in which 3D printing may be done in alternating fashion in both directions (i.e. 3D printing occurs left-to-right in a first row and right-to-left in a subsequent row).

To keep the rows of pulses lined up, the lasing apparatus may be programmed to incorporate a laser on adjust which is a delay function for each alternating row to keep the pulses lined up. For example, at ˜22.5 m/see 3D printing surface velocity an 8 micro see delay is used for alternating rows. Typical bitmap laser software setups allow one to select a single pulse spacing or pitch that is common in both the X and Y directions. A similar contrast can be created for both human legible (e.g. text) and machine readable (e.g. UPC, QR codes) objects by creating different X and Y distances.

The laser on adjust is an element of the turnaround profile of the laser beam sweep path. The turnaround profile refers to the path followed by the galvo set directing the laser beam while the laser beam is turning around between rows (i.e. after 3D printing a row left-to-right, turning around to 3D print a subsequent row right-ot-left). The laser is typically off (i.e. not emitting pulses) during the turnaround. The laser on adjust helps align the 3D prints within adjacent rows. For example, when the grid is a stacked grid, the laser on adjust ensures that the 3D prints in adjacent rows remain stacked. If an offset grid were used, then the laser on adjust would ensure that the grid remains offset, and that the amount of the offset remains relatively constant. The laser on adjust may be determined experimentally and generally varies with angular velocity of the galvo sets.

The turnaround profile of the laser beam after completing a row can also contribute to reduced cycle time. As discussed previously, the laser beam is steered by a galvo set and the ability of the galvo set to accelerate and decelerate is a known limitation to speed and accuracy of laser 3D printing in other (e.g. vector) 3D printing processes. The current CV-bitmap process overcomes these limitations. For example, the current CV-bitmap process does not accelerate or deaccelerate the laser beam while the laser is emitting pulses (i.e. making laser 3D prints). Instead, the laser beam is only being accelerated/decelerated while the laser is not 3D printing the part, such as when the laser beam is skipping multiple voids (or even entire rows) or while the laser beam is turning-around at the end of a row and prior to 3D printing a subsequent row. The turnaround profile may be symmetric or asymmetric. Given the high speeds at which the laser beam sweeps across the surface of the part, an asymmetric turnaround profile may be preferred.

As mentioned previously, the geometry of the 3D print spacing is a key contributor to the cycle time. As discussed, spreading out the locations within the grid (i.e. increasing the X- and Y-distances) can result in decreasing cycle time. Within the rows, the X-distance contributes to cycle time in that the laser surface velocity is determined by the laser repetition rate and the X-distance. Increasing the Y-distance improves cycle time by reducing the number of turnarounds that the galvo sets have to make (i.e. the number of rows comprising the predetermined feature) which may take up to 30-70% of the total cycle time at high speeds. For example, one can make the X distance smaller and the Y distance larger to get a similar looking image at a reduced overall cycle time. It has further been found that reducing the X-distance concurrently with increasing the Y-distance provides for faster cycle time and improved legibility of the 3D printed feature.

The choice of the orientation of the 3D printing direction can also affect job cycle time at very high surface velocity. At very high surface velocities, the turnaround time can increase to the point where it dominates the job cycle time. Selecting the 3D printing direction to be generally parallel to the longer dimension of the feature minimizes turnarounds and can reduce job cycle time. As previously discussed, the X- and Y-distances may be different, and this difference can contribute to reduced job cycle, and any loss in strength or increase in porosity of the 3D partcan be compensated by decreasing the spacing in any of the other directions.

In the laser 3D printing process of the present invention, the laser source is stationary, and the laser beam is guided by the lasing apparatus including a series of lenses and mirrors which are controlled by an algorithm. The algorithm is able to read a digital image of the desired 3D print-pattern (e.g. from a PDF file of the desired image) and translate the image to the 3D print-pattern on the target.

### Microscopy

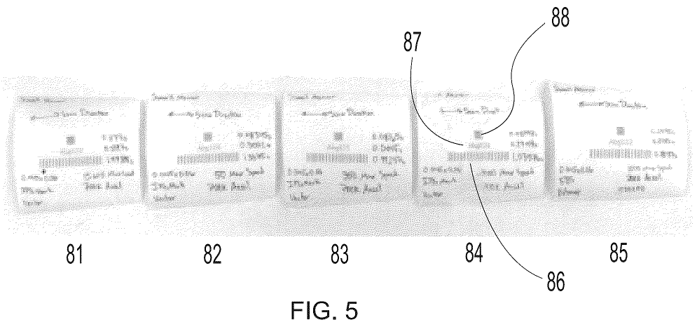

Numerous parts were 3D printed according to the processes of the present invention as well as comparative parts 3D printed with existing processes. Results of those comparisons are given in Tables 1, 2 and 3, as well as FIG. 5. To obtain these comparative data, samples are cut from laser 3D printed HDPE blow molded bottles containing TiO₂ using utility knife and scissors. If the cut-out sample is not suitably flat, the sample is flattened onto the microscope stage by use of tape or a frame. A stereomicroscope such as a motorized Zeiss SteREO Discovery. V20 (Carl Zeiss Microscopy, LLC, Thornwood, NY) equipped with color camera such as the Axiocam 305 (5 megapixel CMOS, Carl Zeiss Microscopy, LLC, Thornwood, NY) is used to image characters, digits and images of interest of the sample using reflected light illumination such as achieved with a LED ring light and light source such as a Cold-light source CL 6000 LED lamp (Carl Zeiss Microscopy, LLC, Thornwood, NY). A typical light intensity of 80-100% of the maximum light intensity is used. The individual laser 3D printings that combine to form the character, digit, or images of interest are resolved using suitable magnification using an objective lens such as an Achromat S 1.5x FWD 28 mm (Carl Zeiss Microscopy, LLC, Thornwood, NY) combined with a zoom factor such that the total magnification is between 10× and 345×. By way of example, characters, digits, or images with a font size of 10 pt, the total magnification is about 40× magnification. After the digit of interest is brought into view of the camera, the character, digit, or image is brought into focus using manual skill or, preferably using the autofocus module via the user interface platform (such as Zen V2.6 Blue Edition or higher with Zen Autofocus module, Carl Zeiss Microscopy, LLC, Thornwood, NY). Prior to collecting an image of the characters, digits, or image, the imaging settings are optimized by using an auto exposure option from the user interface platform along with the lamp intensity. Images are collected in the highest resolution format possible, such as ZVI, then exported as Tiff files having resolution of about 2464×2056 pixels. Furthermore, the 3D printed rows of the character, digit, or artwork should be nearly parallel with the horizontal borders of the image. If required, multiple images taken at higher magnification may be accurately stitched together to encompass the full area of the character, digit or image.

### Image Analysis

The images from the microscope appear gray but are captured in color. The images are converted to gray scale using an NTSC protocol. A suitable image analysis software is required to perform this and several other image processing steps. Analysis functions implemented by MATLAB available from The Mathworks, Inc., Natick, MA are referenced in this method description.

The microscopy and subsequent image analysis may be pursued over one or more predetermined patterns, a portion of a predetermined pattern, or an individual image within a predetermined pattern such as a graphic or an alphanumeric character. Where the image analysis is to be performed over a portion of a predetermined pattern, prior to the analysis, the portion (such as an individual graphic or alphanumeric character) must be separated from any surrounding images, characters or artwork. A mask may be drawn around the character or image of interest in the predetermined pattern. The mask separates the character or image from other partial characters, digits, bar codes, artwork, dirt or other imperfections that may occur in the image.

The image analysis relies first on identifying the laser 3D prints that comprise the image. The laser 3D prints can be identified by any reasonable means. For example, by repeatedly thresholding the grayscale image from the microscopy. The start threshold is set to capture only a few pixels that fall in some of the 3D printings. The threshold value then progressively changes, capturing an ever-increasing area of the 3D prints. The progressive thresholding continues from the start threshold to a stop threshold. The stop threshold may be determined automatically such as by using MATLAB's “multithresh” function (i.e. Otsu's method). Progressive thresholding can be advantageous in the analysis because the area of 3D printings may overlap and/or merge and the background may not be perfectly uniform. The direction of the threshold progression (i,e, light-to-dark or dark-to-light) can be used to identify dark 3D printings versus a relatively light background or light 3D printing versus a relatively dark background. In the example presented, dark 3D prints are identified versus a relatively light background.

Connected components may then be used to identify individual 3D prints once the area reaches a certain size. A connected-components algorithm is executed with each new threshold to group touching pixels into blobs. When a blob reaches 50% of the area for a 3D print, it is identified as a 3D print. The center coordinates of the 3D prints are found using a centroid method as implemented in MATLAB's “regionprops” function. The centers are subsequently used (see below) to determine spacings among adjacent 3D prints in a row (e.g. the X-distance) and spacing between adjacent rows of 3D prints (e.g. the Y-distance).

### Determining the Observed X- & Y-Distances and Standard Deviations

An exemplary means to determine the X-distance and Y-distance, as well as their standard deviations, can also be done using the image analysis, though one of skill in the art will appreciate that any means of determining these distances and standard deviations may be used. One means of determining these values by image analysis includes the use of “Delaunay Triangles”. For the Delaunay Triangle method, center coordinates of the 3D prints are passed to MATLAB's “Delaunay Triangulation” function which creates a triangulation based on the center points. Edges of a Delaunay triangulation never cross and the center points are connected in a nearest-neighbor manner.

The X-distance is taken as the distance between adjacent 3D printed locations along a given row within the grid. The adjacent 3D printed locations along a given row result in a horizontal edge within the Delaunay Triangulation data structure. These horizontal edges can be separated from other edges in the triangulation by calculating the angle of the edge. A horizontal edge in a row of the grid will be within +/−10 degrees of the horizontal edge of the image. The grid consists of a periodic spacing of locations along the rows, so the X-spacings should be relatively consistent (e.g. have a low standard deviation). In this analysis a horizontal edge with a length greater than 2 times the programmed distance can be eliminated from consideration as indicative of a non-adjacent location. The observed X-distance determined when analyzing an image such as an alphanumeric character is, then, taken as the average length of horizontal edges between adjacent 3D prints for all 3D prints/rows within the given image or character. The X-distances for a plurality of characters in a macroscopic image can then be averaged further to provide an average X-distance for a given 3D printing condition and a given image or predetermined pattern. Table 1 depicts the observed X-distance for the characters/digits associated with the depicted UPC code for a series of 3D printing conditions.

The Y-distance can be determined as the vertical distance between adjacent rows. In the Delaunay Triangulation a horizontal edge can be part of 2 adjacent triangles. Each base edge contributes 2 vertices to each of the triangles and the third vertex is the nearest-neighbor 3D print in the adjacent row either above or below the base edge.

For each of the base edges, the perpendicular distance to the nearest 3D print above and below the base edge is determined. Only the minimum (i.e. nearest) of these two distances is recorded. Using only the minimum distance helps ensure that the row is adjacent and helps prevent double-counting of rows. The average and standard deviation of these perpendicular distances over a given image is then taken as the average Y-distance and standard deviation for the image. The topmost and bottommost rows of the character/digit are not used as the base of measured triangles as they have only one adjacent row. The Y-distances for a plurality of images in a predetermined pattern or portion thereof can then be averaged further to provide an average Y-distance and standard deviation for a given predetermined pattern or portion thereof (such as for a given alphanumeric character).

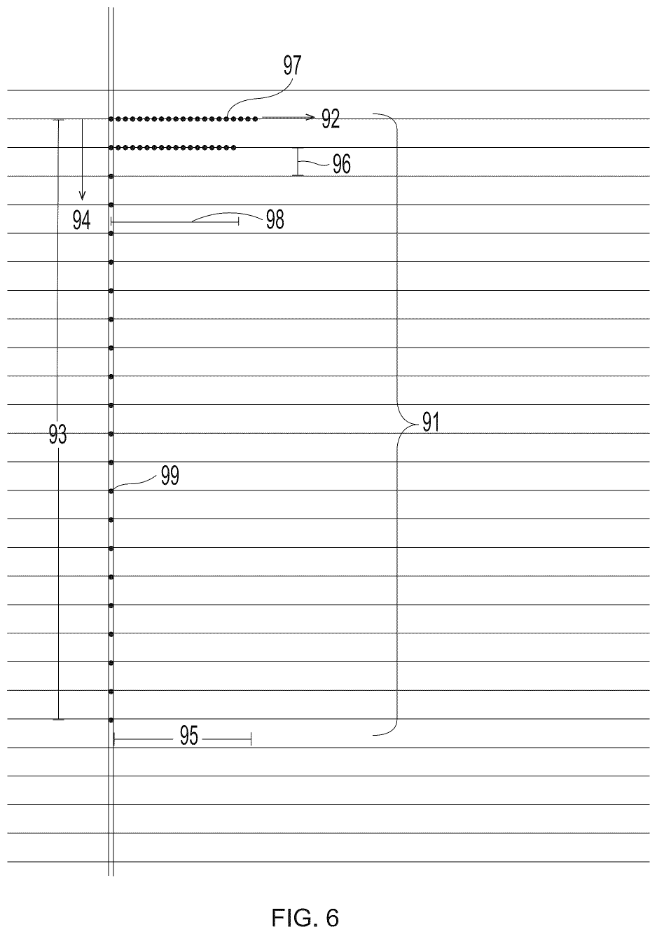

As shown in FIG. 4B, the vector laser 3D printing process at high speed can result in substantial displacement or overhang of 3D prints or voids within a row, resulting in blurred images (such as alphanumeric characters) with a jagged outline. The inventive laser-3D printing process, and parts 3D printed thereby, does not result in such substantial displacement and blurring. Any of a number of means can be used to express the displacement within the rows including simple visual inspection. For example, such a means may include simply observing the character (or other element of a predetermined pattern) and assessing whether it is legible or not, given prior knowledge of the intended 3D printed pattern (e.g. the alphanumeric character). The displacement can also be quantified. Importantly, human- and machine-readable patterns generally include a “smooth” outline (versus the jagged outline shown in FIG. 6B). Said another way, for user-readable and machine-readable patterns, the left-most and right-most 3D printed locations within a given row or 3D printed portion of a row, generally are not substantially displaced (in the X-direction) from the left-most and right-most 3D printed locations (respectively) in the adjacent rows (above and below) relative to the X-distance. This displacement of 3D printed locations results in blurry and ill-defined patterns which creates a larger pattern/character than intended and diminishes both user and machine readability.

In the quantification of displacement, the start-point of each 3D printed portion within a row for a given character or pattern element is taken as the left-most 3D print and the finish-point of each 3D printed portion within a row taken as the right-most 3D print. The start-points and finish-points for each 3D printed portion within a row is determined relative to the corresponding start-point and finish-point (respectively) of the adjacent rows above it and below it. The row under consideration is determined to be “displaced” on the left-side of the character/patter element if the start-points of both the row above and the row below are left of the measured row's start-point, and the row under consideration is determined to be “displaced” on the right-side if the finish-points of both the row above and the row below are right of the measured row's finish-point. The horizontal distance from the start-point (and finish-point) of the row to the start-points (and finish-points, respectively) of the rows above and below are determined, and the displacement is taken as the shorter of these two distances. The left-side displacement being the displacement determined by the start-points and the right-side displacement being the displacement determined by the finish-points. A 3D printed portion within a row may include no displacement, either left- or right-side displacement or both left- and right-side displacement. The top-most and bottom-most rows comprising the image being analyzed (i.e. an alphanumeric character) are omitted from the analysis, as they do not have two adjacent rows. One means to identify the start and finish points of each row uses the Delaunay Triangulation analysis previously discussed for determining the X- and Y-distance(s) and standard deviation(s).

The “% Displacement” for a given image such as an alphanumeric character is the sum of the displacements for the rows comprising the character divided by the number of rows making up the character.

% Displacement=(total displacement in the character)/(number of rows in the character)*100

The “A % D” or Average % Displacement for a predetermined pattern comprising multiple alphanumeric characters as text, is simply the sum of the % Displacement for each character in a sample set divided by “n” the number of characters in the sample.

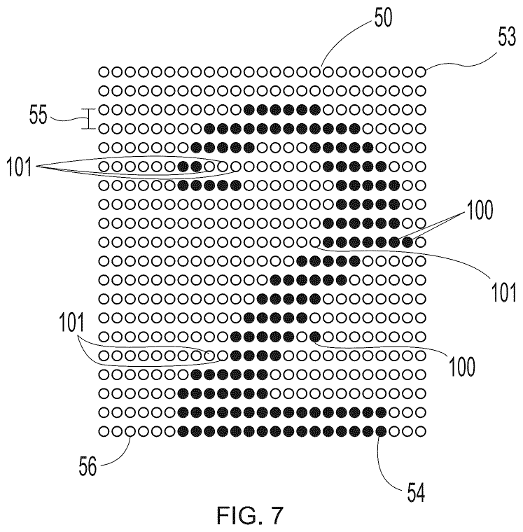

Yet another method of quantifying the precision of the high-speed laser 3D printing of the present invention is the percent of mis3D printed locations, or “% Mismarked”. Referring now to FIG. 7, which shows the alphanumeric character “2” 3D printed in a grid pattern according to the present invention. There are approximately 130 3D printed locations 54. In FIG. 7, there are 8 voids 101 that should be 3D printed locations. Further, there are 4 3D printed locations 100 that should be voids. As should be apparent, both the voids that should be 3D printed locations and 3D printed locations that should be voids are mis-3D printed mistakes, accordingly they are added together and compared to the number of 3D printed locations. In the example of FIG. 7 there are 12 mistakes (8+4) out of a total of 130 desired 3D printed locations. The % Mismarked=the number of mistakes divided by the number of desired 3D printed location times 100, ((12/130)*100)=9.23%. FIG. 4B shows an egregious mis3D printed alphanumeric character (“2”) wherein the % Mismarked is greater than 20%.

The “average % Mismarked” for a predetermined pattern comprising multiple alphanumeric characters as text is simply the sum of the % Mismarked for each alphanumeric character divided by the number of alphanumeric characters. To achieve the desired readability of text comprised of the alphanumeric characters the average % Mismarked of the alphanumeric characters is less than about 20%, preferably less than about 15%, more preferably less than about 10% and even more preferably less than about 5%. For both the % precision calculation and the standard deviation provision, the following criteria will be used to calculate the averages.

### Samples and Data

Table 1 displays data obtained by laser 3D printing four different parts with the same pattern, and then analyzing them using the methods described above. The 3D printing in this case was an industry standard UPC code. Those skilled in the art will appreciate that a UPC, which must appear on all consumer purchased goods, must have clearly defined black bars and alphanumeric characters against a lighter, preferably white, background in order for a UPC scanner to read the code quickly and accurately. Said another way, UPC codes must be printed or 3D printed with precision to be accurately read by a scanner or person. By way of example, FIG. 7 shows UPC code 70 laser 3D printed according to the processes of the present invention. UPC code 70 is a mixture of bars 72 of varying width, and alphanumeric characters 74.

Before the present invention, vector laser 3D printing was the fastest available laser 3D printing system, but Table 1 clearly shows that as the speed of vector 3D printing increases the precision of the 3D printing decreases substantially. More specifically, vector 3D printing was tested at a maximum galvo angular velocity of 15.6, 350, and 1000 radians per second and compared to the CV-bitmap 3D printing of the present invention at a maximum surface velocity of 1000 radians per second. The target Y-distance is provided in the first row, and the actual Y-distance for each of the n samples was measured (in mm) and then averaged. More importantly, sigma σ, the standard deviation, was calculated for the n samples using a standard mathematical formula. The standard deviation is a measure of how far away the individual samples deviated from the target Y-distance. For example, if only two samples were run at a target Y-distance of 0.150, and one sample was 0.200 and the other was 0.100 their average would be exactly 0.150, the target value. But the precision would be awful. The standard deviation in this example would be a large number indicating the lack of precision for these two hypothetical samples where their average would look to be on-target.

Comparing vector 3D printing at a galvo angular velocity of 15.6 radians per second (the first entry in Table 1) to CV-bitmap 3D printing at 1000 radians per second (the last entry in Table 1), the average X-distance and the average Y-distance, and the corresponding standard deviations, are similar across the four target X- and Y-distances tested. When the galvo angular velocity of the vector 3D printing is increased to 1000 radians per second, the average X-distance and corresponding standard deviation remain reasonable, but the Y-distance standard deviation becomes unacceptable, and UPC codes are ultimately unreadable, both in terms of a machine reading the barcode and a human reading the underlying numeric characters. For the UPC code 3D printed by the process of the present invention, both the average X-distance and standard deviation and the average Y-distance and standard deviation, even at a maximum galvo angular velocity of 1000 radian per second, are very good. Accordingly, the CV-bitmap laser-3D printing of the present invention provides the clear benefit of speed and precision over the prior vector 3D printing systems.

$$s = \sqrt{\frac{\sum {( {x}_{i} - \overline{x} )}^{2}}{n - 1}}$$

Where S=σ=the standard deviation; n=the number of samples used; xᵢ=the individual deviations from the mean for each sample; and, x=the mean, or simple average of the samples. It is understood that σ, the standard deviation, has units of mm (millimeters). Those skilled in the art will appreciate that “relative” standard deviation is often reported as well. Relative standard deviation is unitless because relative standard deviation=(σ mm/σ Average mm).

When determining the Average % Displacement or the Average % Mismarked over a series of alphanumeric characters such as text, the sample size must include at least 6 different alphanumeric characters selected from the group consisting of S, s, R, r, T, t, N, n A, a, E, e, O, o, U, u, 1, 2, 3, 4, 5, 6, 7, 8, and 9 and the sample size should be no more than 10 alphanumeric characters. Further, the alphanumeric characters should be within the range of 6 pt to 16 pt font size (approximately 2.1 mm to 5.64 mm tall).

TABLE 1
3D printing Precision versus speed: X,Y-Distances in mm
Xₜ, Yₜ, = the target X and Y distances
n = the number of samples tested
X,Y = the average X,Y-distance for the n samples tested
σ = the standard deviation of the X,Y-distance for the n samples tested
A % D = The Average % D for the n samples

| | Galvo | | | | |
|---|---|---|---|---|---|
| | Mirror | Target Distances | Target Distances | Target Distances | Target Distances |
| | VelMax | Xₜ = 0.045 | Xₜ = 0.045 | Xₜ = 0.045 | Xₜ = 0.050 |
| | (rad/sec) * | Yₜ = 0.150 mm | Yₜ = 0.105 mm | Yₜ = 0.060 mm | Yₜ = 0.050 mm |
| Vector | 15.6 | X = 0.051 σ0.007 | X = 0.051 σ0.007 | X = 0.051 σ0.007 | X = 0.056 σ0.007 |
| | | Y = 0.154 σ0.005 | Y = 0.106 σ0.006 | Y = 0.057 σ0.005 | Y = 0.046 σ0.005 |
| | | A % D = 22.7% | A % D = 18.7% | A % D = 13.1% | A % D = 15.0% |
| | | (0.011/0.051) | (0.009/0.051) | (0.007/0.051) | (0.008/0.056) |
| | | n = 7 | n = 7 | n = 6 | n = 7 |
| Vector | 350 | X = 0.047 σ0.004 | X = 0.047 σ0.003 | X = 0.047 σ0.003 | X = 0.052 σ0.004 |
| | | Y = 0.150 σ0.007 | Y = 0.103 σ0.010 | Y = 0.056 σ0.011 | Y = 0.046 σ0.012 |
| | | A % D = 134.2% | A % D = 163.8% | A % D = 166.3% | A % D = 150.0% |
| | | (0.063/0.047) | (0.077/0.047) | (0.078/0.047) | (0.078/0.052) |
| | | n = 7 | n = 7 | n = 8 | n = 7 |
| Vector | 1000 | X = 0.048 σ0.004 | X = 0.048 σ0.005 | X = 0.048 σ0.005 | X = 0.053 σ0.006 |
| | | Y = 0.164 σ0.043 | Y = 0.121 σ0.045 | Y = 0.069 σ0.031 | Y = 0.061 σ0.029 |
| | | A % D = 387.0% | A % D = 479.4% | A % D = 468.0% | A % D = 428.3% |
| | | (0.184/0.048) | (0.229/0.048) | (0.224/0.048) | (0.228/0.053) |
| | | n = 7 | n = 7 | n = 6 | n = 6 |
| CV- | 1000 | X = 0.047 σ0.004 | X = 0.047 σ0.003 | X = 0.046 σ0.002 | X = 0.052 σ0.002 |
| Bit | | Y = 0.151 σ0.006 | Y = 0.102 σ0.006 | Y = 0.055 σ0.006 | Y = 0.045 σ0.007 |
| Map ** | | A % D = 34.3% | A % D = 34.0% | A % D = 40.6% | A % D = 56.7% |
| | | (0.016/0.047) | (0.016/0.047) | (0.019/0.046) | (0.029/0.052) |
| | | n = 7 | n = 7 | n = 9 | n = 7 |

* This column represents the Maximum Galvo Speed available for the equipment used, not the actual speed. Please see also Table Three where the Maximum Galvo Speed appears in Row 3.
** surface velocity = 22.5 m/s for X (target) = 0.045 mm; surface velocity = 25 m/s for X (target) = 0.050 mm

Table 2 is another set of comparative data wherein the UPC codes were laser 3D printed with legible precision. That is, at each speed and at each target Y and X distance, the time it took to create a machine readable UPC was measured. As is clearly shown, with each successive increase in Velocity Max, the time required to laser-3D print the UPC code in a precise/readable manner actually took longer for the vector 3D printing process.

TABLE 2
Total Time to 3D print (seconds)
All X and Y-distances are in mm

| | VelMax | X = 0.045 | X = 0.045 | X = 0.045 | X = 0.050 |
|---|---|---|---|---|---|
| | (rad/sec) | Y = 0.150 | Y = 0.105 | Y = 0.060 | Y = 0.050 |
| Vector | 15.6 | 2.92 | 4.15 | 7.27 | 8.72 |
| Vector | 350 | 2.32 | 3.29 | 5.77 | 6.93 |
| Vector | 1000 | 3.22 | 4.56 | 7.99 | 9.86 |
| CV- | 1000 | 0.34 | 0.40 | 0.59 | 0.66 |
| BitMap | | | | | |

Table 3 contains data taken from the laser 3D printed samples shown in FIG. 5. The top line of Table 3 indicates which of the five samples shown in FIG. 5 (81-85) the data corresponds to, how each sample was laser 3D printed, and how it compares to the other samples. FIG. 5 shows 5 mm squares 88, sample text 87 (alpha numeric characters “Abg123”), and a series of 1 mm by 5 mm rectangles 86 which are spaced apart by 1 mm. The repetition rate is 500 khz using normal acceleration rate of 700,000 rad/sec². Line two of Table 3 shows how each sample was 3D printed, line 3 is the maximum galvo angular velocity of the laser 3D printing, and the fourth and fifth rows are a qualitative description of the results. The actual data for the 3D printing the 5 mm squares 88, the text 87, and the 1 mm by 5 mm Standardized Rectangles 86 is shown in the remaining lines of Table 3. Once again, it is quite clear that the speed and precision of laser 3D printing according to the CV-bitmap of the present invention is far superior to the prior vector 3D printing systems. An f-theta lens was used with a 250 mm focal length.

TABLE 3

| FIG. 8 Dwg No. | 81 | 82 | 83 | 84 | 85 |
|---|---|---|---|---|---|
| 3D printing Type | Vector | Vector | Vector | Vector | CV-Bitmap |
| Max Velocity | 15.6 | 50 | 350 | 1000 | 1000 |
| Threshold | | | | | |
| (rad/sec) | | | | | |
| Cycle Time | Slowest | Slower | Slow | Slow | Fast |
| | | | | | (~1.5-8x |
| | | | | | faster |
| | | | | | vs vector) |
| Dot or Pulse | Best | Better | Good | Bad | Better |
| Quality | | | | | |
| (Legibility) | | | | | |
| Cycle time (s) | 0.117 | 0.083 | 0.082 | 0.088 | 0.060 |
| to print a 5 mm | | | | | |
| Square | | | | | |
| 88 FIG. 8 | | | | | |
| Vector vs. CV- | 197% | 140% | 137% | 148% | N/A |
| Bitmap | | | | | |
| cycle time | | | | | |
| Text (Abg123) | 0.340 | 0.300 | 0.245 | 0.295 | 0.071 |
| 87 FIG. 8 | | | | | |
| (time, s) | | | | | |
| Vector vs. CV- | 476% | 421% | 343% | 413% | N/A |
| Bitmap | | | | | |
| cycle time | | | | | |
| Standardized | 1.494 | 1.335 | 0.993 | 1.036 | 0.185 |
| Rectangles | | | | | |
| (time, s) | | | | | |
| (1 mm × 5 mm, | | | | | |
| spaced 1 mm | | | | | |
| apart) | | | | | |
| 86 FIG. 8 | | | | | |
| Vector vs. CV- | 809% | 723% | 537% | 561% | N/A |
| Bitmap | | | | | |
| cycle time | | | | | |

### Standardized Rectangle Method

The Standardized Rectangle method is a standardized test to measure both speed and accuracy of any lasing apparatus. Simply put, any lasing apparatus that can be programmed to print 20 identical rectangles (similar to a simplified UPC code) can be tested. The details of the test are given below, but those skilled in the art will appreciate that the time it takes to print the Standardized Rectangles is important in demonstrating the benefit of this invention. The last two lines of Table 3 show examples of the times needed to print the Standardized Rectangles with four lasing apparatuses/processes available today and one lasing apparatus/process according to the present invention. The prior lasing apparatuses/processes needed from 1.5 to 1.0 seconds to print the Standardized Rectangles. The lasing apparatus/process according to the present invention needed only 0.185 second, 500%-800% faster than the prior devices.

As shown in FIG. 5, the Standardized Rectangles 86, are a series of 20 identical rectangles 91, of FIG. 9, that are approximately 1 mm wide 95 by approximately 5 mm high 93 and spaced apart by about 1 mm. The rectangles width 95 must be in the range of 0.94 mm and 1.22 mm. The rectangles height 93 must be in the range of 4.8 mm to 5.00 mm. Each rectangle contains 80-84 parallel rows 97. Each row is in the X-direction 92, that is, across the 1 mm width 98. Accordingly, the Y-distance 96, the distance between rows, is in the range of 0.24 mm-0.26 mm. There are 20-24 3D prints 99 in each row 97. Obviously, not all the 3D prints 99 are shown for purposes of clarity.

All percentages are weight percentages based on the weight of the composition, unless otherwise specified. All ratios are weight ratios, unless specifically stated otherwise. All numeric ranges are inclusive of narrower ranges; delineated upper and lower range limits are interchangeable to create further ranges not explicitly delineated. The number of significant digits conveys neither limitation on the indicated amounts nor on the accuracy of the measurements. All measurements are understood to be made at about 25° C. and at ambient conditions, where “ambient conditions” means conditions under about one atmosphere pressure and at about 50% relative humidity.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A 3D part printed by a pulse lasing apparatus, the part comprising:
A series of over-lying layers wherein each layer comprises a plurality of 3D prints;
wherein pulses from the pulse lasing apparatus form the 3D prints and the absence of a pulse forms the voids,
wherein the pulse lasing apparatus is controlled by a computing device that sends packets of instructions to the pulse lasing apparatus, the packet of instructions comprising at least 2 individual instructions, wherein each individual instruction informs the laser to pulse or not to pulse.

2. The 3D part of claim 1, wherein the over-lying layers comprise 3D prints and voids in a grid pattern, the grid pattern comprising a plurality of locations disposed along a series of substantially parallel rows, wherein each location comprises either one 3D print; and,
wherein pulses from the pulse lasing apparatus form the 3D prints and the absence of a pulse forms the voids; and,
wherein each individual instruction informs the laser to pulse or not to pulse, creating a 3D print or a void, respectively, at each location on the grid pattern.

3. The part of claim 1, wherein the grid patterns comprise locations disposed along the rows with each pair of adjacent locations being separated by an X-distance; and
wherein there are two or more substantially parallel rows and each adjacent pair of substantially parallel rows is separated by a Y-distance.

4. The part of claim 3, wherein the Y-distance is greater than the X-distance.

5. The part according to claim 1, wherein the locations between adjacent parallel rows are stacked.

6. The part according to claim 1, wherein the locations between adjacent parallel rows are offset.

7. The part according to claim 1, wherein the locations in the two-dimensional layers are stacked in the Z-direction.

8. The part according to claim 1, wherein the locations in the two-dimensional layers are offset in the Z-direction.

9. The part according to claim 1, wherein the individual instructions can be any combination of 3D prints and voids including all 3D prints or all voids.

10. A method of 3D printing a part by a pulse lasing apparatus, the method comprising the steps of:
defining a series of over-lying layers comprising a plurality of 3D prints and voids in a grid pattern, the grid pattern comprising a plurality of locations disposed along a series of substantially parallel rows, wherein each location comprises either one 3D print or one void;
forming the 3D prints by pulsing the pulse lasing apparatus and creating voids by not pulsing the pulse lasing apparatus; and,
controlling the pulse lasing apparatus with a computing device that sends packets of instructions to the pulse lasing apparatus, the packet of instructions comprising at least 2 individual instructions, wherein the individual instruction inform the pulse lasing apparatus to pulse or not to pulse, creating a 3D print or a void, respectively, at each location on the grid pattern.

11. The method according to claim 10, wherein at least one of the rows are 3D printed by 2 different packets.

12. The method of claim 10, wherein the packet of instructions further contains two or less, preferably, only one individual instruction relating to the position of a location in the grid pattern.

13. A part 3D printed by a pulsed laser comprising a predetermined grid pattern:
wherein the grid pattern comprises a plurality of locations positioned in two or more rows, wherein the two or more rows are substantially parallel, each adjacent pair of locations of the plurality of locations along any of the two or more rows is separated by an X-distance and each adjacent pair of the two or more rows is separated by a Y-distance;
wherein the beam of the pulsed laser moves across the rows at a constant surface velocity greater than about 8 m/s, preferably 14 m/s, more preferably 18 m/s, and even more preferably 22 m/s as consecutive 3D prints are formed; and,
wherein the Y-Distance standard deviation less than about 0.040, preferably less than about 0.034, preferably less than about 0.028, more preferably less than about 0.010, and even more preferably less than about 0.005.

14. The part of claim 13, wherein the beam of the pulsed laser moves in a bi-directional profile such that the laser beam moves along a first row in a first direction and a second row in a second direction.

15. The part of claim 13, wherein the beam of the pulsed laser beam is directed by two galvo sets each comprising a mirror and a galvanometer, wherein the angular velocity of the rotation of at least one galvo set is greater than about 40 rad/sec, preferably 56 rad/sec, more preferably 72 rad/sec, and even more preferably 90 rad/sec.

16. The part of claim 13, wherein the beam of the pulsed laser has a repetition rate greater than about 100 kHz.

17. A part 3D printed by a pulsed laser comprising a series of over-laid 3D printed layers, each comprising a predetermined grid pattern:
wherein the grid pattern comprises a plurality of locations positioned in two or more rows, wherein the two or more rows are substantially parallel, each adjacent pair of locations of the plurality of locations along any of the two or more rows is separated by an X-distance and each adjacent pair of the two or more rows is separated by a Y-distance;
wherein the beam of the pulsed laser moves across the rows at a constant surface velocity greater than about 8 m/s, preferably 14 m/s, more preferably 18 m/s, and even more preferably 22 m/s as consecutive marks are formed; and,
wherein the grid pattern has an Average % Displacement less than about 150%, preferably less than about 120%, preferably less than about 100%, more preferably less than about 70%, and even more preferably less than about 50%.

18. The part of claim 17, wherein the beam of the pulsed laser beam is directed by two galvo sets each comprising a mirror and a galvanometer, wherein the angular velocity of the rotation of at least one galvo set is greater than about 40 rad/sec, preferably 56 rad/sec, more preferably 72 rad/sec, and even more preferably 90 rad/sec.

19. A part 3D printed by a pulsed laser comprising a series of over-laid 3D printed layers, each comprising a predetermined pattern of locations each comprising a 3D print or a void in a grid pattern:
wherein the grid pattern comprises a plurality of locations positioned in two or more rows, wherein the two or more rows are substantially parallel, each adjacent pair of locations of the plurality of locations along any of the two or more rows is separated by an X-distance and each adjacent pair of the two or more rows is separated by a Y-distance;
wherein the beam of the pulsed laser moves across the rows at a constant surface velocity while pulsing greater than about 8 m/s, preferably 14 m/s, more preferably 18 m/s, and even more preferably 22 m/s as consecutive 3D prints are formed; and,
wherein the average % Mismarked is less than about 20%, preferably less than about 15%, more preferably less than about 10% and even more preferably less than about 5%.

20. A part having a surface 3D printed by a pulsed laser comprising a first predetermined pattern of locations each comprising a 3D print or a void in a grid pattern and a second predetermined pattern of locations each comprising a 3D print or a void in a grid pattern:
wherein the first and second grid patterns comprise a plurality of locations positioned in two or more rows, wherein the two or more rows are substantially parallel, wherein each adjacent pair of locations of the plurality of locations along any of the two or more rows is separated by an X-distance and each adjacent pair of the two or more rows is separated by a Y-distance; and,
wherein the first and second grid patterns differ in at least one of the X-distance and the Y-distance; and,
wherein the pulsed laser has a beam that moves across the rows at a constant surface velocity while pulsing greater than about 8 m/s, preferably 14 m/s, more preferably 18 m/s, and even more preferably 22 m/s as consecutive 3D prints are formed.
